(19) United States
(12) Patent Application Publication
(10) Pub. No.: US 2023/0003669 A1
(43) Pub. Date: Jan. 5, 2023

(54) MOISTURE SENSING USING RADIO FREQUENCY IDENTIFICATION (RFID)

(71) Applicant: Drexel University, Philadelphia, PA (US)

(72) Inventors: Md Abu Saleh Tajin, Philadelphia, PA (US); Kapil R. Dandekar, Philadelphia, PA (US)

(73) Assignee: Drexel University, Philadelphia, PA (US)

(21) Appl. No.: 17/929,059

(22) Filed: Sep. 1, 2022

Related U.S. Application Data
(60) Provisional application No. 63/239,464, filed on Sep. 1, 2021.
(60) Provisional application No. 63/074,290, filed on Sep. 3, 2020.

(51) Int. Cl. G01N 22/04; H01Q 9/26; H01Q 1/27; H01Q 1/22

(52) U.S. Cl. CPC G01N 22/04; H01Q 9/26; H01Q 1/273; H01Q 1/2208

(57) ABSTRACT

A passive UHF (Ultra High Frequency, 902-928 MHz) RFID-based fabric (such as a diaper) moisture sensor is low-cost, user-friendly, reusable, washable, environment-friendly and comes with an extended on-body read range of 3.6 meters with baby diapers and 4.4 meters with adult diapers. The external reader unit is connected to the internet or a local network, and may automatically notify the parents or caregivers as soon as the presence of moisture is detected.

### STATEMENT REGARDING GOVERNMENT SUPPORT

This invention was made with government support under Contract No, CNS-1816387 awarded by the National Science Foundation. The government has certain rights in the invention.

### BACKGROUND

Caregivers or parents who attend seniors or babies have to manually check for the presence of urine in diapers. Currently, almost all diapers come with pH-activated yellow stripes that turn blue when the diaper is wet. The caregiver has to check multiple times for a change in color. Patients with bowel incontinence need to have their diaper changed immediately after it is soiled. The longer a patient is exposed to a soiled diaper, the higher the risk of skin breakdown, potentially leading to life-threatening infections.

Depending on the power source at the user end, wireless moisture sensors can be divided into three categories: active, semi-passive, and passive. Active and semi-passive sensors require a local power source at the sensor end, while passive sensors function without a local power source. Active and semi-passive sensors are bulky, costly, and often infeasible for applications where the sensor is disposable. While passive sensors are light and cheap, they suffer from limited read ranges. Previously, a few HF (high frequency) passive RFID moisture sensors have been proposed. Those sensors have 26.3 cm and 12 cm read ranges, respectively. Sen et al. developed a hydrogel-based UHF (Ultra High Frequency) passive RFID diaper wetness sensor with a read range of 1m. The sensor is a bow-tie antenna that includes metal and hydrogel that gets increased in size when exposed to urine. The increased antenna size leads to increased backscattered power by the tag. This is the first proposed UHF-based diaper moisture sensor. Chen et al. constructed a textile-based RFID moisture sensor that senses the RSSI (Received Signal Strength Indicator) difference between a reference tag and a tag exposed to moisture. The textile moisture sensor tag takes 5 minutes for a “slight” bending, and 1 hour to form a semicircle. It might be challenging to incorporate this technology into diaper moisture sensing applications.

Commercially available passive RFID-based sensors can detect liquid level. However, they have not been used for smart diaper applications. The IC (integrated circuit) can track antenna detuning due to the proximity of liquid. The limitation of only chip detuning-based sensing is that the input impedance of the chip is a function of the received power. As a result, the distance between the reader and the tag needs to be fixed. Passive RFID-based glass water level indicators can detect the level of liquid beverage in a glass or a container. Similarly, RFID tag antenna-based liquid level detectors have been developed using a similar RSSI tracking method for medical transfusion applications. Tanaka et al. developed a flexible battery-powered sensor urinary incontinence sensor with a 5 m read range. However, the design is bulky and takes more than five minutes to provide a sensing decision. Active and semi-passive smart diapers are also available in the literature.

A summary of existing approaches to wireless moisture sensing techniques is given in FIG. 17, Table I.

### SUMMARY OF THE EMBODIMENTS

Passive RFID (Radio Frequency Identification) systems have evolved at an unprecedented rate in the past decade. State-of-the-art tags can operate at significantly lower power levels. For example, the Monza R6 chip (2017) has a read sensitivity of up to-22.1 dBm, while the Monza-2 (2006) chip has a read sensitivity of −11.5 dBm. In other words, the Monza R6 chip requires 11.5 times less power compared to what is needed to drive a Monza-2 chip. Such an evolution in only eleven years is truly extraordinary. The lower activation energy of modern tag chips has extended the read range. The increased read range opens the door for new passive RFID-based sensors that are practical for many IoT (Internet of Things) applications, including the applications herein.

In the proposed sensor technology, a flexible, reusable, and battery-free RFID tag is attached to the front side of the diaper. An external RFID reader/interrogator antenna energizes and monitors the tag. As soon as there is a presence of urine, the tag on the diaper may reflect little or no interrogation energy, resulting in a sharp decline in RSSI (Received Signal Strength Indicator). As a result, an alarm may be generated, requesting a diaper-change. With a single interrogator antenna, it is possible to serve multiple users.

Commercially available RFID tag antennas are generally miniaturized meandered folded-dipole structures, with an omnidirectional radiation pattern. This is true for free-space (relative permittivity, air=1). However, in the presence of a material with higher electrical permittivity (e.g., water=80), a large portion of the radiated power is absorbed, leading to poor radiation efficiency. On the same note, about 60% of the human body consists of water. Textile-based folded dipole RFID antennas drastically lose radiation efficiency in the proximity of the human body. As a result, the read range of the passive tag is significantly decreased. We have successfully exploited this phenomenon in the design of a moisture sensor. Since we place the tags on the outer side of the diaper, the chip circuitry does not get damaged.

Currently, almost all diapers come with a pH-activated yellow straight line, which turns blue when the diaper is wet. However, the caregiver has to check many times for a change in color. Patients with bowel incontinence need to have their diaper changed, immediately after it is soiled. The longer a patient is exposed to a soiled diaper, the higher is the risk of skin breakdown, potentially leading to life-threatening infections. In a facility where multiple seniors/babies are attended by a single caregiver, our technology may provide instant notification of wetness in the diaper and allow for monitoring of many patients at once, saving time for the caregiver. Moreover, the risks of diaper-related infections may be greatly reduced. This technology could be applied in both residential and medical applications.

The proposed system is very cost-effective and environmentally-friendly. Further, according to testing, the proposed moisture sensing technology provides a 4.4 m reading/working range. This is the highest among other passive RFID-based moisture sensors available in the literature. The proposed sensor not only has the longest read range among UHF (Ultra High Frequency) RFID smart diapers but by the introduction of a reference tag, it also can detect ambiguities arising from user movement or external blockages.

This description simulates and experimentally validates the diaper sensing technology. Human urine has an electrical conductivity ranging from ˜0.1 to 3.4 S/m with a mean value of 2.2 Si/m. The electrical conductivity of seawater is 4 Si/m (source: HFSS), and the relative permittivity (or dielectric constant) of urine is close to that of seawater (81, source: HFSS). Therefore, the inventors chose seawater for simulating moisture. The moisture sensor experiments mentioned herein are designed to operate in the ISM band (902-928 MHz) in the US, and the simulations are performed at 913 MHz.

In a facility where multiple seniors/babies are attended by a single caregiver, the proposed moisture sensor may provide instant notification of wetness in the diaper, saving time for the caregiver. Smart diapers can automatically store urination data, and the physicians can use this to gain important insight regarding the health of the user. Moreover, the risks of diaper-related infections may be greatly reduced.

Although diapers and urine are discussed herein, the sensor could be mounted to any wearable garment, device, or fabric where moisture could be detected.

### BRIEF DESCRIPTION OF THE EMBODIMENTS

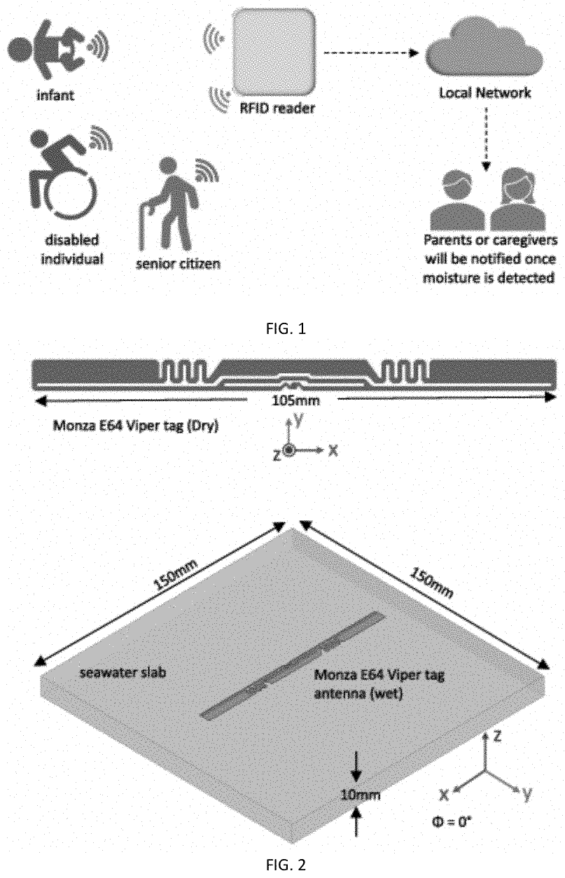

FIG. 1 shows an overview of a system with the sensor in use.

FIG. 2 shows a A Monza E64 Viper tag antenna in free-space and a tag antenna in the presence of a seawater slab where the antenna is placed 5 mm above the slab.

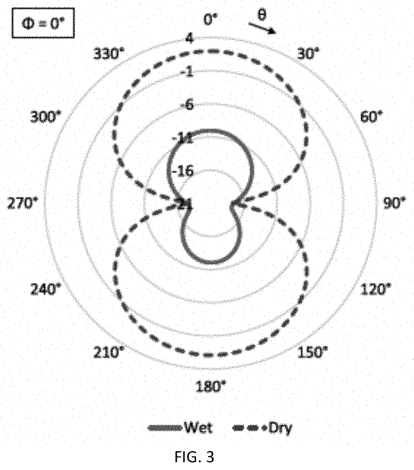

FIG. 3 shows simulated gain patterns of tag antenna at dry and wet conditions in free-space. The volume of the seawater slab is 250 mL (W=150 mm), and the separation between the antenna and the slab is 5 mm. The radii of the polar plot indicate gain in dBi.

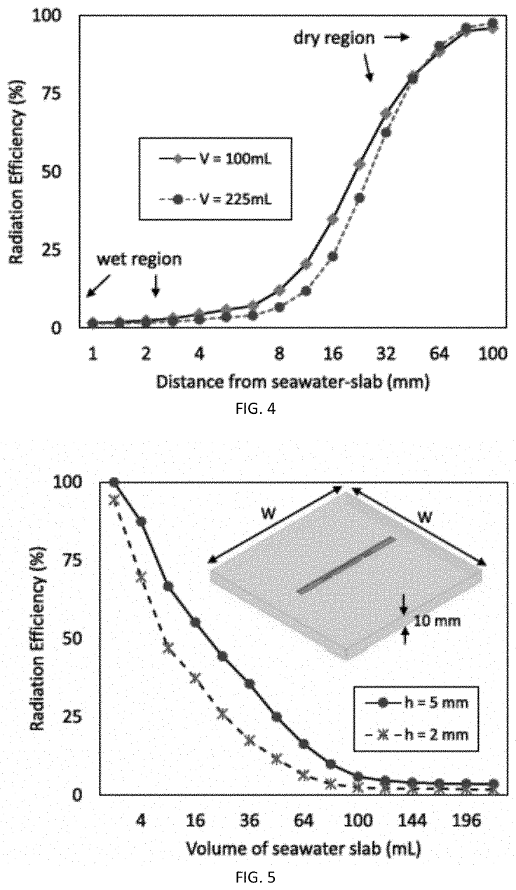

FIG. 4 shows simulated radiation efficiency vs distance from water slab (225 mL) at 913 MHz.

FIG. 5 shows simulated radiation efficiency vs seawater slab volume at 913 MHz. The thickness of the slab is fixed at 10 mm, while the length of each side is varied from 10 mm to 150 mm at 10 mm steps.

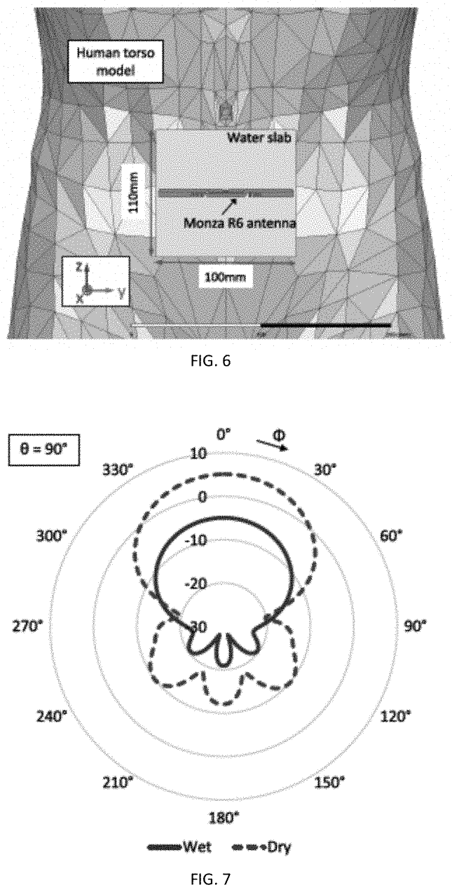

FIG. 6 shows simulation of moisture sensor tag in HFSS on a male torso model.

FIG. 7 shows simulated gain pattern at dry and wet conditions on-body. Seawater slab volume is 110 mL, and separation between antenna and slab is 5 mm. The radii of the polar plot indicate gain values in dB. In the ‘wet’ state, the maximum gain drops significantly.

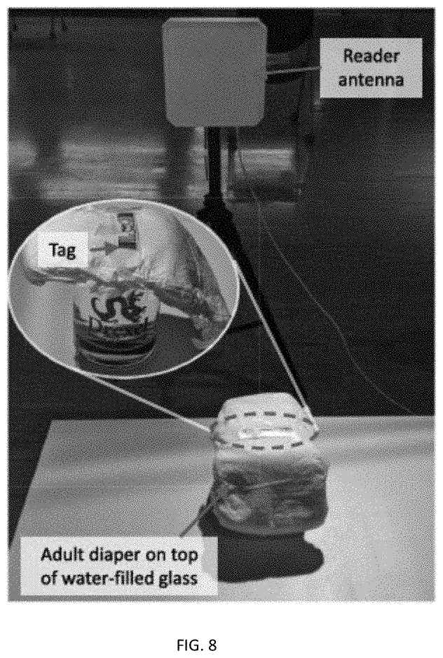

FIG. 8 shows a free-space moisture sensing setup. A diaper is placed on top of a glass full of water, 1m away from a circularly polarized high gain reader antenna.

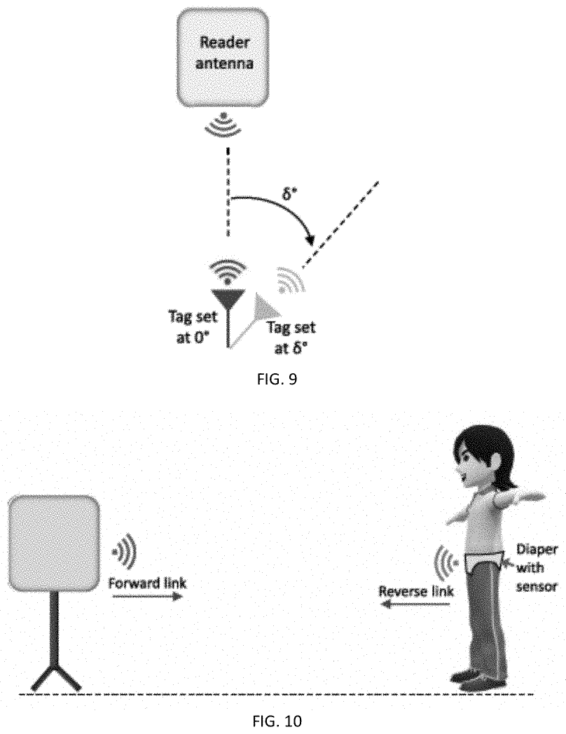

FIG. 9 shows a setup for testing the effects of rotation. The main and reference tags are attached to a piece of adult diaper, facing the reader antenna from 1 m distance.

FIG. 10 shows diaper wetness sensing test on-body.

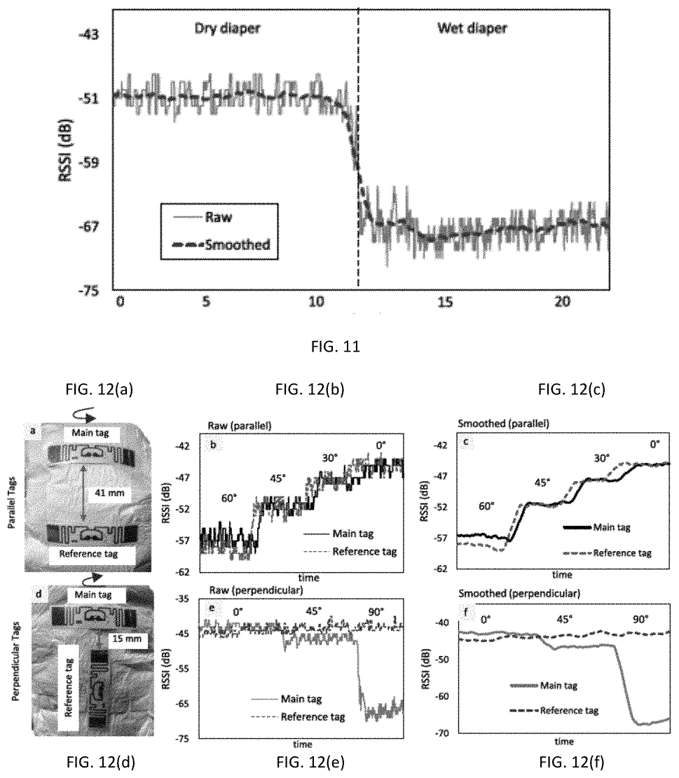

FIG. 11 shows RSSI vs time plot for the free-space experimentation. The distance between the reader and the tag is 1m.

FIGS. 12(a)-12(f) show 12(a) A parallel combination of main and reference tags, 12(b) raw RSSI changing with the horizontal rotation of the parallel tags attached to the diaper in free-space, 12(c) smoothed RSSI in the parallel combination, 12(d) perpendicular combination of main and reference tags, 12(e) raw RSSI changing with the horizontal rotation of the perpendicular tags attached to the diaper in free-space, 12(f) smoothed RSSI in the perpendicular combination.

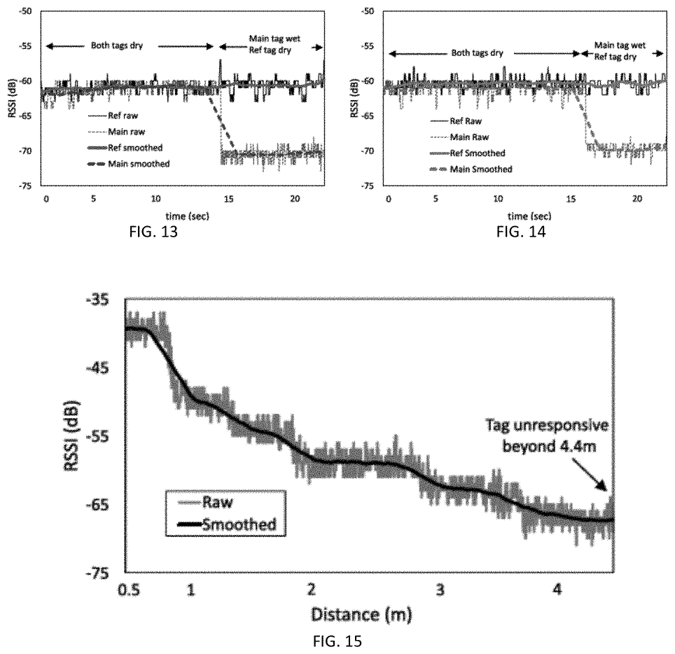

FIG. 13 shows RSSI vs time plot when the on-body reference tag is parallel to the main tag. In the dry state, the diaper is dry. During the wet state, the diaper region behind the main tag absorbs water and the area behind the reference tag remains dry.

FIG. 14 shows RSSI vs time plot for the on-body perpendicular reference tag orientation. The decline in RSSI due to the presence of moisture is similar to the parallel tag orientation.

FIG. 15 shows RSSI vs distance between the dry tag on-body and the reader antenna. The RSSI decreases as the separation between the tag and the reader antenna increases. The tag becomes unresponsive if the line-of-sight distance exceeds 4.4 m.

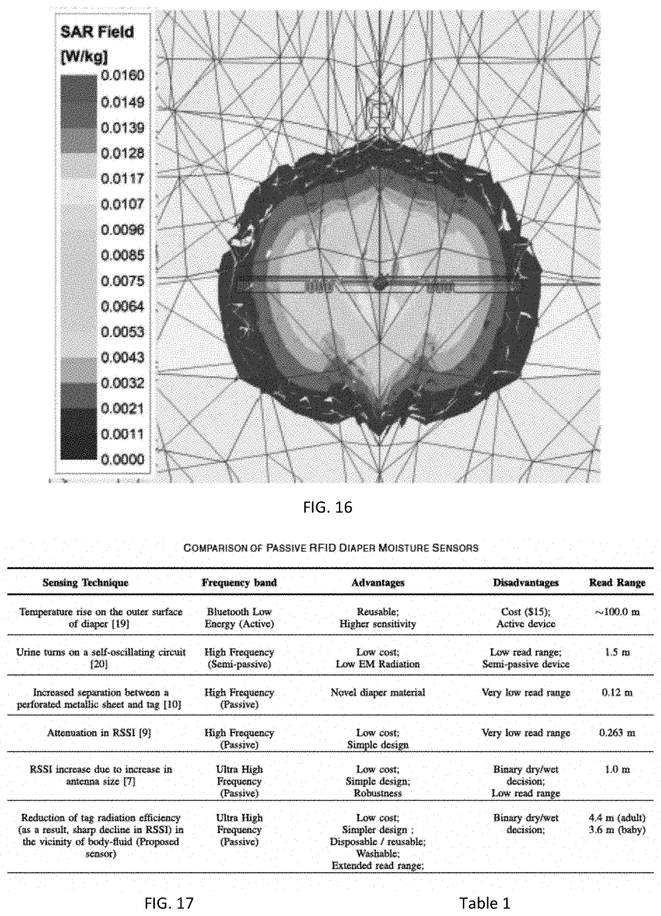

FIG. 16 shows specific Absorption Rate (SAR) simulation inside the human body at 913 MHz (dry state). The tag antenna is driven on the human body model at an input power of 0.21 W. The maximum simulated SAR is 0.016 W/kg, significantly lower than the maximum allowable value 1.6 W/kg.

FIG. 17 shows Table I.

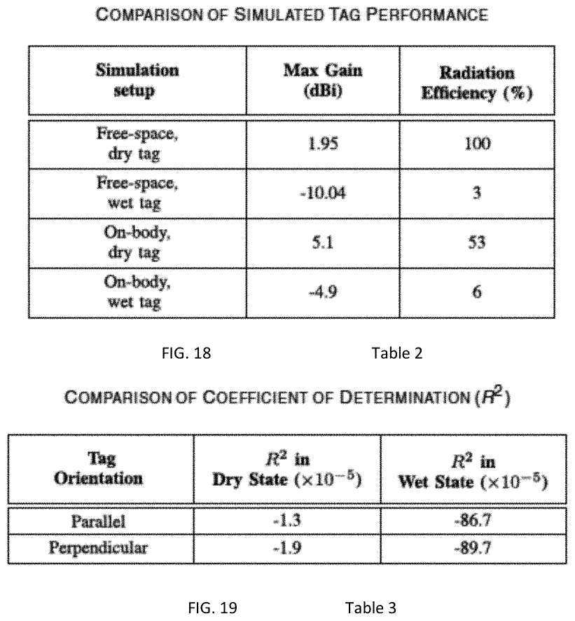

FIG. 18 shows Table 2.

FIG. 19 shows Table 3.

### DETAILED DESCRIPTION OF THE EMBODIMENTS

I. Introduction

FIG. 1 shows an overview of a system where battery-less moisture sensor is attached to a diaper on an infant, disabled individual, or senior citizen. The RFID reader antenna externally energizes the tag circuitry. If the sensor detects wetness, a notification is sent to the parents or caregivers in charge.

With the technology herein, a disposable, flexible, and battery-free RFID tag may be attached to the front side of the diaper. An external RFID interrogator antenna may power-up and monitor the tag. As soon as there is a presence of urine, the tag on the diaper may be out of monitoring, and an alarm may be generated requesting a diaper-change. With a single interrogator antenna, it is possible to serve multiple users.

II. Simulation

A. Free-Space Simulation

The radiation efficiency of an antenna is dictated by the conductive and dielectric losses incurred by the antenna. Radiation efficiency,

ηrad=P_{rad}/(P_{rad}+P_{R}+P_{D}) EQ. 1

where ηrad, Prad, PR, and PD are radiation efficiency, radiated power, ohmic loss, and dielectric loss, respectively. The inventors simulated a Monza E64 Viper tag antenna (that is optimized to be used with Monza R6 RFID tag chips) (FIG. 2) using HFSS (High-Frequency Structure Simulator) in both dry and wet states to understand and validate the effects of moisture on the radiation efficiency. The antenna is a partially meandered folded dipole, matched to the chip impedance in the UHF band (902-928 MHz). The size of the antenna is 105 mm×6 mm×0.1 mm. In both cases of the simulation, the tag antenna is fed with a lumped port. In the dry state, the antenna has an omnidirectional radiation pattern (FIG. 3) with a maximum gain of 2.13 dB at 913 MHz. Since the antenna material is designed as a perfect electrical conductor and there is no dielectric loss, the radiation efficiency of the antenna in the ‘dry’ state is ≈100%. We place a 150 mm×150 mm×10 mm hypothetical slab of seawater, 5 mm below the tag antenna. The volume of the seawater slab is 225 mL which is lower than bladder capacity (300-550 mL) of an adult.

FIG. 4 shows that the radiation efficiency of the tag antenna is 1.3% for 1 mm spacing, and 3% for 5 mm spacing. It takes about 100 mm spacing between the tag antenna and the seawater slab for the antenna to recover its free-space radiation efficiency. We find that the average distance between moisture and the sensor tag (or the thickness of the water-resistant outer layer of the diaper) is less than 5 mm. We repeat the simulation by reducing the volume of the seawater slab to 100 mL.

Due to the higher relative permittivity of seawater, the electric fields are strongly coupled with the water slab, compared to air. The water slab introduces dielectric loss to the antenna. As a result, the radiation efficiency of the antenna drops significantly. FIG. 4 shows the simulated radiation efficiency as a function of the distance (h) between the antenna and the seawater slab. As the separation increases, the antenna begins to recover its free-space efficiency. Compared to adults, children have a smaller bladder capacity. The capacity is 10 mL in neonates and 48-60 mL in a 9-month-old. In the third year, the bladder significantly grows to 123-150 mL. To show the effect of urine volume on the sensing capabilities of the proposed sensor, we simulate the radiation efficiency at varying seawater volumes, at 2 mm and 5 mm separations from the tag antenna. The thickness of the slab is fixed at 10 mm. The volume is varied by changing the length of each edge from 10 mm to 150 mm, at 10 mm steps. In this way, the volume of the seawater slab under the tag antenna varies from 1 mL to 225 mL.

FIG. 5 shows the effect of the seawater slab volume on the simulated radiation efficiency of the sensor tag antenna. For a 1 mL slab, the radiation efficiency of the antenna is 99.9%, and for a 9 mL slab, the radiation efficiency drops down to 66.7%. These results show that the sensor can be used for smart diaper applications in neonates. When the slab volume is 121 mL (lower range of bladder volume in a 9-month-old), the radiation efficiency sharply drops to 4.6%. As a result, the sensor would be more effective in detecting moisture in a 9-month-old. Since the radiation efficiency vs seawater volume curve has consistently negative slopes, the sensing capabilities would be even better for adults.

B. On-Body Simulation

Once the point of diminishing radiation efficiency has been established, the inventors moved to a more practical scenario where the seawater slab area is smaller (110 mm×100 mm×10 mm) in the wet case and the antenna is placed 34 mm (approximate distance between the users' body and the tags) away from a male human torso model (FIG. 6). The moisture sensing tag antenna is placed around the lower frontal region of diapers. That part of the diaper is loosely bound to the body to ensure user comfort.

From lab trials, the inventors observed that the separation between the antenna and the human body is 34 mm, on average. A distance larger than 34 mm may even facilitate the sensor by reducing the effects of body-proximity in the dry-state. The seawater slab is absent in the dry state. FIG. 7 shows the gain pattern in the azimuth plane (θ=90°, φ variable). Unlike the free-space scenario, both patterns, in this case, are directional. This is due to the fact that the human body is present in both cases (dry and wet). As a result, the backward radiation (θ=90°, φ=180°) is largely blocked by the body.

III. Experimental Setup

The experimental setup is divided into two categories:

Free-space test, and (ii) On-body test Each category is divided into two subcategories, namely “dry” and “wet” states.

A. Single Tag in Free Space

The inventors cut a section of a commercially available adult-diaper and attached a Monza R6-based commercial RFID tag on the outer side. A glass is filled with water and the top is covered with thin and transparent plastic tape. The diaper, with the tag on top, is placed on the water-filled glass. The plastic cover prevents the inside of the diaper from absorbing water from the glass. A circularly polarized reader antenna is placed 1m away from the tag (FIG. 8). The maximum gain of the antenna is 9 dBi. An Impinj speedway Revolution R420 reader drives the antenna with 28 dBm input power. Considering 1 dB loss due to the coaxial cable running from the reader to the antenna and the associated connectors, the maximum effective isotropically radiated power (EIRP) is 36 dBm. This is the maximum allowable power limit for UHF (902-928 MHz) RFID applications imposed by the Federal Communications Commission (FCC) in the United States. There are 50 frequency-hopped UHF channels within the band. This is the ‘dry’ state of the free-space experimentation.

After recording the ‘dry’ state readings for a few seconds, the inventors gently removed the plastic layer from the top of the glass and tried to leave the tag as much undisturbed as possible while handling the tape. As soon as they placed the diaper on top of the glass, the inside of the diaper quickly absorbs water to create the “wet” state. Since the outer part of the diaper is water-resistant, the tag does not come into direct contact with water. As a result, the tag can be reused.

B. On-Body Read Range Measurement

In free space, the tag attached to a diaper can be read from a large range (around 7 m line-of-sight). However, to evaluate its on-body performance, it may be important to measure the on-body read range. To demonstrate the on-body read range of the sensor, a tag is attached to the outer surface of an adult diaper and the diaper is worn by a standing human subject, facing the reader antenna from a distance of 0.5 m. The human subject moves away from the reader antenna in 0.5 m steps until the tag is out of range.

C. Reference Tag

Since the diaper moisture sensor is based on the received signal strength (RSSI), moisture might be falsely detected for different reasons. Some of these reasons are as follows:
An increase in the distance between the reader and the sensor tag,
A rotation of the sensor tag away from the reader,
Introduction of a blockage between the reader and the sensor tag,
Damage to the sensor tag.

To address these issues, the inventors introduce another passive RFID tag, identical to the main tag, that would act as a reference. By taking sensing decisions based on the comparison of RSSI from both tags, the system can successfully cancel out the false-positive results. The reference tag, identical to the main tag, can be placed parallel or perpendicular to the main tag (FIGS. 12a, 12d). FIG. 9 demonstrates the setup for the rotation test of the tag set (main tag and reference tag) on top of an adult diaper in free-space for both parallel and perpendicular orientations. In the parallel orientation, the tags are placed 41 mm apart (FIG. 12a). The separation is 15 mm (edge to edge) in the perpendicular orientation. The distance between the tags and the reader antenna is 1 m in both cases.

Input power from the reader is 28 dBm, and the reader antenna gain is 9 dBi. At 0°, the tag set attached to the diaper is directly facing the reader antenna. The system records RSSI for both tags as the tag duo rotates (δ°) away from the reader antenna. Since the goal of the reference tag is to emulate the RSSI level of the main tag as closely as possible, the parallel orientation may work better in this setting. However, if the tags are closely spaced, their mutual coupling may be strong (co-polarized tag antennas). On the other hand, if the tags are perpendicular to each other, the effect of mutual coupling would be small (cross-polarized tag antennas) compared to its parallel counterpart.

D. On-Body Test With Reference Tag

A diaper is placed on the lower abdominal area of a male human subject (FIG. 10). Two Monza R6-based commercial UHF RFID tags are attached to the water-resistant outer layer of the diaper using transparent adhesive tapes. The two tags are parallel to each other and stay 44 mm apart from each other (edge to edge). The RFID reader antenna is placed at a 2 m distance from the tag set. The FCC in the United States requires that the minimum distance between the reader and the human body is 20 cm. The reader antenna directly faces the diaper. The system records the RSSI and repeat the experiment by changing the orientation of the reference tag from parallel to perpendicular to the main tag. Since the diaper is dry, this is the ‘dry’ state of the on-body test. In the ‘wet’ state, the inventors add 100 mL of water to the back of the diaper with a bulb syringe so that the area behind the main tag is wet, but the area behind the reference tag is dry. The added water is quickly absorbed by the diaper, while the water-resistant outer layer of the diaper maintains a strict separation between the tag and moisture.

IV. Results and Discussion

The simulated radiation pattern (at 913 MHz) of the tag antenna is omnidirectional and symmetric about the azimuth plane when the antenna is dry and in free-space (FIG. 3). However, the vicinity of the seawater slab not only disturbs the symmetry in the gain pattern but also reduces the maximum gain. The seawater slab largely blocks the backward radiation (θ=180°) and introduces significant dielectric loss. Maximum gain along the φ=0°, θ=0° direction is 1.95 dBi in the dry state. The wet state (250 mL seawater slab) gain is −9.2 dBi. Radiation efficiency is 100% and 3% in dry and wet states, respectively. In the on-body simulation (FIG. 7), both patterns are asymmetric about the XY-plane. In the dry state, the peak gain 5.1 dBi is observed along the φ=0°, θ=90° direction. On the other hand, peak gain in the wet state drops to −4.9 dBi. In the on-body case, the maximum gain is higher in both cases compared to the free-space case. The higher gain is achieved at the expense of lower radiation efficiency. The radiation efficiency is defined as the ratio of the maximum gain to the maximum directivity (Radiation efficiency=Gain(max)/Directivity(max)). The radiating beam is highly directive in the on-body case, and the radiation efficiency is 53% and 6% in the dry and wet cases, respectively. The wet state on-body radiation efficiency is higher compared to the free-space case because we are using a smaller seawater slab (110 mL) in the on-body case, which results in a lower dielectric loss. The simulated performance of the tag antenna in different scenarios is summarized in FIG. 18, Table II.

In the free-space experiment, the average RSSI for the dry diaper is around −51 dB (left region, FIG. 11). In the second region, the RSSI falls sharply by about 17 dB as water rushes into the diaper. During the on-body experiment, the average RSSI level of the dry tags in both parallel and perpendicular orientations is −62 dB (FIGS. 13 and 14, left regions). With the introduction of water, the RSSI plummets swiftly. The average RSSI in the wet state is around −70 dB. With the introduction of water, the average RSSI drops by at least 9 dB in both cases, which offers a significantly large range for moisture detection. The direction of the maximum gain of the tags is directed towards the reader in the on-body scenario. On the other hand, in the free-space experiment, the maximum gain direction is perpendicular to the reader antenna direction. As a result, the RSSI drop is higher in the free-space wet cases.

In the parallel orientation of the tag set, both tags (main and reference) show similar back-scattered power levels (RSSI) as the tags rotate towards the reader (FIGS. 12b-c). In the perpendicular orientation, the main tag RSSI decreases rapidly (FIGS. 12e-f) as the tags rotate away from the reader. However, the reference tag RSSI remains unchanged. This behavior is related to the radiation patterns of the tags. At δ=0°, both tag antennas have their main lobes facing towards the reader antenna. But at δ=90°, while the main lobe the reference tag still faces the reader, one of the nulls (minimum gain position) of the main tag faces the reader antenna. As a result, the main tag receives low power that leads to lower RSSI. Thus, the parallel orientation of the tags may be more suitable for diaper moisture sensing applications.

To quantify the variability of RSSI as a result of wetness, we calculate the coefficient of determination or R2,

$${R}^{2} = 1 - \frac{{{Σ}_{i} ( {y}_{i} - {f}_{i} )}^{2}}{{{Σ}_{i} ( {y}_{i} - \overline{y} )}^{2}} ; i = 1 , 2 , 3 , … , n \qquad ( 2 )$$

where y and f represent the RSSI values of the main and reference tags, or vice-versa. y⁻ is the mean of yi values. An R2 value of 1 indicates a perfect match between the two data sets. In general, as the separation between yi and fi increases, the R2 value becomes increasingly negative. In other words, the R2 value would be highly negative in the wet states. FIG. 19, Table III shows the comparison of R2 for separate dry and wet states in both parallel and perpendicular orientations of the tags.

Besides a good range of RSSI, another important performance metric of the moisture sensor is the maximum allowable line-of-sight (LOS) distance (or read range, d):

$$d = \frac{λ}{4 π} [ {antilog}_{10} ( \frac{- S + {P}_{in} + {G}_{t} + {G}_{r} - PLF}{20} ) ] \qquad ( 3 )$$

where S (dB), Pin, Gr, Gt (9 dBi), ε (0.333 m), d, and PLF (3 dB) are tag sensitivity (dBm), interrogator input power (dBm), receiver gain (dB), transmitter gain (dB), wavelength (meters), read-range (meters), and Polarization Loss Factor (dB) respectively. Total cable and connector loss is approximately 1 dB. To maintain compliance with the FCC limit for Effective Isotropic Radiated Power (EIRP), a maximum power of 28 dBm can be fed to the reader antenna. In other words, the summation of input power (dBm, after considering cable loss etc.) and transmitter gain (dB) should not exceed 36 dBm. The read range of the proposed sensor is partly dictated by the thickness of the diaper. From our experiments in a laboratory environment, we find that the read range of the proposed moisture sensor is 4.4 m with adult diapers (10 mm thick) and 3.6 m with baby diapers (8 mm thick). FIG. 15 shows the decrease in RSSI as the on-body tag moves away from the reader antenna.

The proximity of moisture not only impacts the backscattered power (or RSSI) but also changes the input impedance of the tag antenna. As a result, the tuning between the chip and the antenna is disturbed. The detuning also plays a role in the decline of backscattered power. Nevertheless, many modern RFID chips (e.g. Monza R6 chip used in the proposed sensor tags) come with an “Autotune” feature that incorporates a flexible matching network embedded into the chip so that it can compensate for any disturbance in the chip-antenna tuning.

Depending on the mode of application, the proposed sensor is either disposable or reusable and environment-friendly. For a disposable setup, the sensor tags would be integrated into the diapers during manufacturing. The retail price of a couple of tags is around $0.20. As a result, it would be economically feasible to dispose of the smart diapers after use along with the tags. However, the tag contains plastic and metals which would ideally be reused as much as possible to minimize environmental impact. The tags [3] are covered with PET (polyethylene terephthalate) substrates, and as a result, the proposed sensor is washable. FIG. 17, Table I, compares the performance of a few recent technologies related to passive RFID-based moisture sensing.

A. RF Exposure and Safety

The National Institute of Standards and Technology (NIST) considers RFID to be safe in terms of radiation exposure. Nevertheless, the inventors thus far have investigated the SAR inside the human body with the proposed sensor. FCC imposes a limit on maximum radiation from RF devices by restricting the maximum specific absorption rate (SAR) in the human body (irrespective of gender and age). The maximum allowable SAR is 1.6 W/kg. Any device operating close to the human body with an SAR value lower than 1.6 W/kg is considered safe by the FCC.

Passive RFID tags operate at very low power levels. Moreover, the tag may be dependent on the reader antenna for energy requirements. The reader antenna radiates RF energy below or equal to the 36 dBi maximum EIRP limit imposed by FCC [25]. Moreover, the radiated signal incurs path loss before reaching the passive tags. A portion of the energy captured is being used to run the internal circuitry of the passive tag chip. The rest of the power is reflected by the tag antenna.

The RFID reader may be kept at least 20 cm away from the user's body at all times. The inventors simulate this extreme case to study the maximum possible SAR inside the human body. Moreover, this assumes that no power is dissipated by the chip circuitry, and the chip feeds all available energy to the tag antenna. Under these assumptions, if the antenna input power is 27 dBm, reader antenna gain 9 dBi, receiver (tag antenna) gain 5 dBi, and the separation between the reader and tag is 20 cm, then the power received by the tag antenna at 913 MHz is 23 dBm or 0.21 W. This drives the tag antenna on a simulated human body at 0.21 W power level (FIG. 16). The resultant maximum SAR is 0.016 W/kg. This is significantly lower (100 times lower) than the maximum allowable SAR (1.6 W/kg) in the human body.

V. Other Applications

A few systems found in the literature are based on IR sensors, Bluetooth modules, weight sensors, etc. These devices are active, and their batteries need to be changed manually. Moreover, these systems are expensive. The same is also true for blood transfusion. A passive RFID (Radio Frequency Identification)-based saline level indicator in a saline or blood storage container (or other container) can automate the whole process. Such a system would ensure the patient's safety and increase efficiency by saving nurses'/caregivers' time. The inventors have found only one patent (U.S. Pat. No. 8,500,673) that incorporates active/passive RFID tags in blood level sensing during surgeries. However, the sensing is done using two sliding electrodes. The RFID tag only stores information regarding the container geometry. The tag does not actively take part in sensing. The proposed system would be part of a larger passive RFID-based IoT setup. The reader antenna sctivates and monitor multiple sensors/tags simultaneously. Since the tags are passive, there is no need for batteries. Moreover, the tags are very cheap (˜15 cents each) and disposable and/or reusable. To the inventors' knowledge, they are the first to propose a passive RFID-based saline/blood level sensor, capitalizing antenna gain reduction in the vicinity of the abovementioned fluids.

VI. Conclusion

The inventors propose a low-cost, battery-less, disposable/reusable, washable, and environment-friendly passive RFID-based moisture sensor using commercially available tags. Dry and wet state performance of the sensor is simulated (at 913 MHz) and experimentally validated in both free-space and on-body orientations. The proposed moisture sensor offers a 4.4 m maximum read range for adult diapers and 3.6 m for baby diapers. This is the highest among passive wireless smart diaper technologies found in the scientific literature. Using two identical tags (main and reference) in parallel, the inventors were able to separate incidents leading to RSSI degradation rather than moisture. The limitation of this paper is that the proposed sensor can detect only dry or wet states.

A system may be developed for the detection of different levels of wetness in a diaper from the percentage variation between the main and reference tag RSSI. A machine learning technique may be developed to detect and eliminate false-positive results.

While the invention has been described with reference to the embodiments herein, a person of ordinary skill in the art would understand that various changes or modifications may be made thereto without departing from the scope of the claims.

1. A system for detecting moisture in a wearable garment comprising:
a wearable garment including a passive RFID moisture sensor;
an RFID reader antenna that energizes the passive RFID moisture sensor and receives a signal that varies in the presence of moisture; and
a monitoring system that interprets the signal for a user.

2. The system of claim 1, wherein in the presence of moisture, the passive RFID moisture sensor reflects less interrogation energy from the RFID reader antenna and this results in a weaker signal received at the reader, resulting in an interpretation that the wearable garment is wet.

3. The system of claim 1, wherein the RFID moisture sensor is a folded dipole antenna with an omnidirectional radiation pattern.

4. The system of claim 1, wherein the RFID moisture sensor is placed on an outer edge of the wearable garment.

5. The system of claim 1, wherein the monitoring system, upon determining the presence of moisture, sends a communication to a device alerting a device user to the presence of moisture.

6. The system of claim 1, wherein the wearable garment is a diaper.

7. The system of claim 1, wherein there are multiple wearable garments monitored by the RFID reader antenna.

8. A system for detecting moisture in a container with a fluid therein comprising:
a fluid container including a passive RFID moisture sensor;
an RFID reader antenna that energizes the passive RFID moisture sensor and receives a signal that varies in the presence of moisture; and
a monitoring system that interprets the signal for a user.

9. The system of claim 8, wherein in the presence of moisture, the passive RFID moisture sensor reflects less interrogation energy from the RFID reader antenna and this results in a weaker signal received at the reader, resulting in an interpretation that the fluid container is wet.

10. The system of claim 8, wherein the RFID moisture sensor is a folded dipole antenna with an omnidirectional radiation pattern.

11. The system of claim 8, wherein the monitoring system, upon determining the presence of moisture, sends a communication to a device alerting a device user to the presence of moisture.

12. The system of claim 8, wherein the fluid container contains blood.

13. The system of claim 8, wherein the fluid container contains saline.

14. The system of claim 8, wherein there are multiple fluid containers monitored by the RFID reader antenna.
